(19) United States
(12) Patent Application Publication
(10) Pub. No.: US 2025/0271482 A1
(43) Pub. Date: Aug. 28, 2025

(54) RADAR DETECTION RANGE VISUALIZATION DEVICE AND METHOD THEREOF

(71) Applicant: Xiamen PVTECH Co., Ltd., Xiamen (CN)

(72) Inventors: FUXING LU, Xiamen (CN); RONGHUI WANG, Xiamen (CN)

(21) Appl. No.: 19/052,244

(22) Filed: Feb. 12, 2025

(30) Foreign Application Priority Data
Feb. 23, 2024 (CN) 202410205069.1

(51) Int. Cl. G01R 29/10; G01S 7/06; G01S 7/40

(52) U.S. Cl. CPC G01R 29/10; G01S 7/06; G01S 7/4008

(57) ABSTRACT

A radar detection range visualization device includes a signal detection module, a ranging module and a visualization module. The signal detection module receives a microwave signal from a target radar at each of a plurality of estimated positions. The ranging module calculates the distance between each of the estimated positions and the target radar according to the signal strength of the microwave signal detected by the signal detection module at each of the estimated positions. The visualization module executes a visualization process to generate a visual detection range map according to the coordinate of each of the estimated positions, the signal strength of the microwave signal at each of the estimated positions, and the distance between each of the estimated positions and the target radar.

### BACKGROUND OF THE INVENTION

### 1. Field of the Invention

The present invention relates to a visualization device, in particular to a radar detection range visualization device. The present invention further relates to the method of the radar detection range visualization device.

### 2. Description of the Prior Art

With the advancement of technology, the demand for intelligent applications has been steadily increasing. Microwave detectors play a critical role as key components in realizing various intelligent applications. However, different microwave detectors have varying detection ranges. To determine the detection range of a microwave detector, users must conduct extensive testing and subsequently create a detection range diagram based on the test results. This testing process is highly complex, requiring significant time and manpower. As a result, the currently available testing methods are no longer sufficient to meet actual requirements.

### SUMMARY OF THE INVENTION

One embodiment of the present invention provides a radar detection range visualization device, which includes a signal detection module, a ranging module and a visualization module. The signal detection module receives a microwave signal from a target radar at each of a plurality of estimated positions. The ranging module calculates the distance between each of the estimated positions and the target radar according to the signal strength of the microwave signal detected by the signal detection module at each of the estimated positions. The visualization module executes a visualization process to generate a visual detection range map according to the coordinate of each of the estimated positions, the signal strength of the microwave signal at each of the estimated positions, and the distance between each of the estimated positions and the target radar.

In one embodiment, the visualization module connects the estimated positions to form a closed curve and indicates one or more of the signal strength of the microwave signal at each of the estimated positions and the distance between each of the estimated positions and the target radar, in order to generate the visual detection range map.

In one embodiment, the visualization module calculates a corrected position corresponding to any one of the estimated positions according to the signal attenuation rate of the target radar when the signal strength of the microwave signal corresponding to the estimated position exceeds a preset signal strength, and replaces the estimated position with the corrected position to execute the visualization process.

In one embodiment, the signal strength of the microwave signal corresponding to the corrected position is equal to the preset signal strength.

In one embodiment, the radar detection range visualization device further includes a display module for displaying the visual detection range map.

Another embodiment of the present invention provides a radar detection range visualization method, which includes the following steps: receiving a microwave signal from a target radar at each of a plurality of estimated positions via a signal detection module; calculating the distance between each of the estimated positions and the target radar by a ranging module, according to the signal strength of the microwave signal detected by the signal detection module at each of the estimated positions; and executing a visualization process via a visualization module to generate a visual detection range map according to the coordinate of each of the estimated positions, the signal strength of the microwave signal at each of the estimated positions, and the distance between each of the estimated positions and the target radar.

In one embodiment, the step of executing the visualization process via the visualization module to generate the visual detection range map according to the coordinate of each of the estimated positions, the signal strength of the microwave signal at each of the estimated positions, and the distance between each of the estimated positions and the target radar further includes the following step: connecting the estimated positions to form a closed curve and indicate one or more of the signal strength of the microwave signal at each of the estimated positions and the distance between each of the estimated positions and the target radar by the visualization module in order to generate the visual detection range map.

In one embodiment, the step of executing the visualization process via the visualization module to generate the visual detection range map according to the coordinate of each of the estimated positions, the signal strength of the microwave signal at each of the estimated positions, and the distance between each of the estimated positions and the target radar further includes the following step: calculating a corrected position corresponding to any one of the estimated positions according to a signal attenuation rate of the target radar when the signal strength of the microwave signal corresponding to the estimated position exceeds a preset signal strength, and replacing the estimated position with the corrected position to execute the visualization process by the visualization module.

In one embodiment, the signal strength of the microwave signal at the corrected position is equal to the preset signal strength.

In one embodiment, the method further includes the following step: displaying the visual detection range map by a display module.

The radar detection range visualization device and method thereof in accordance with the embodiments of the present invention may have the following advantages:

(1) In one embodiment of the present invention, the radar detection range visualization device includes a signal detection module, a ranging module and a visualization module. The signal detection module receives a microwave signal from a target radar at each of a plurality of estimated positions. The ranging module calculates the distance between each of the estimated positions and the target radar according to the signal strength of the microwave signal detected by the signal detection module at each of the estimated positions. The visualization module executes a visualization process to generate a visual detection range map according to the coordinate of each of the estimated positions, the signal strength of the microwave signal at each of the estimated positions, and the distance between each of the estimated positions and the target radar. As such, the radar detection range visualization device can implement a specialized visualization mechanism to automatically generate the visual detection range map, which significantly reduces radar testing time, thereby lowering time and labor costs. Accordingly, the radar detection range visualization device can meet actual requirements.

(2) In one embodiment of the present invention, the visualization module of the radar detection range visualization device can connect the estimated positions to form a closed curve and indicate one or more of the signal strength of the microwave signal at each of the estimated positions and the distance between each of the estimated positions and the target radar, in order to generate the visual detection range map. Consequently, the visual detection range map produced by the radar detection range visualization device can include a lot of useful information, such that the radar detection range visualization device can conform to actual requirements.

(3) In one embodiment of the present invention, the visualization module of the radar detection range visualization device can calculate a corrected position corresponding to any one of the estimated positions according to a signal attenuation rate of the target radar when the signal strength of the microwave signal corresponding to the estimated position exceeds a preset signal strength, and replace the estimated position with the corrected position to execute the visualization program. In this way, the radar detection range visualization device can execute a visual detection range map optimization process in order to enable the visual detection range map to accurately display the actual detection range of the target radar, which can improve the precision of the visual detection range map.

(4) In one embodiment of the present invention, the radar detection range visualization device further includes a display module capable of directly displaying the visual detection range map. The display module makes the radar detection range visualization device be more convenient in use and more comprehensive in application. Thus, the radar detection range visualization device can meet the requirements of different applications.

(5) In one embodiment of the present invention, the radar detection range visualization device features a simple design and offers a variety of functions. As such, the radar detection range visualization device achieves higher practicality and can be applied to various intelligent applications. Consequently, the radar detection range visualization device aligns with future development trends.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a block diagram of a radar detection range visualization device in accordance with one embodiment of the present invention.

FIG. 2 is a schematic view of the radar detection range visualization device in accordance with one embodiment of the present invention.

FIG. 3 is a block diagram of a radar detection range visualization device in accordance with another embodiment of the present invention.

FIG. 4 is a flow chart of a radar detection range visualization method in accordance with still another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

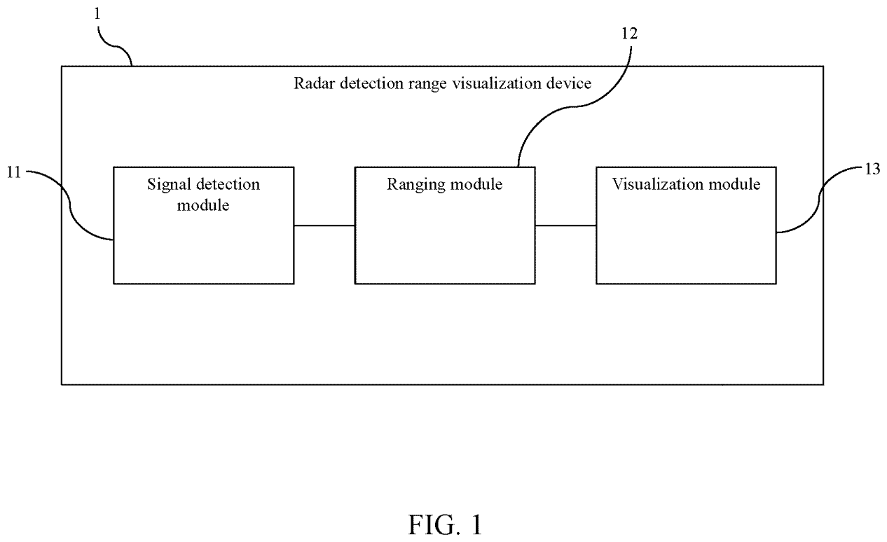

Please refer to FIG. 1, which illustrates a block diagram of a radar detection range visualization device in accordance with one embodiment of the present invention. As shown in FIG. 1, the radar detection range visualization device 1 includes a signal detection module 11, a ranging module 12, and a visualization module 13. The radar detection range visualization device 1 may be disposed below the target radar to perform a visualization process. The target radar refers broadly to various radar technologies based on radio technology, such as microwave radar or millimeter-wave radar.

A user can select a plurality of estimated positions within the possible detection range of the target radar and place the signal detection module 11 at each estimated position to receive microwave signals from the target radar. In one embodiment, the signal detection module 11 may be a microwave signal receiver or other similar components.

The ranging module 12 is connected to the signal detection module 11. The ranging module 12 calculates the distance between each estimated position and the target radar according to the signal strength of the microwave signal detected by the signal detection module 11 at each estimated position. In one embodiment, the ranging module 12 may be a microcontroller (MCU), central processing unit (CPU), application-specific integrated circuit (ASIC), field-programmable gate array (FPGA), or other similar components.

The visualization module 13 is connected to the ranging module 12. The visualization module 13 executes the visualization process to generate a visual detection range map according to the coordinates of the estimated positions, the signal strengths of the microwave signals at the estimated positions, and the distances between the estimated positions and the target radar. The visualization module 13 then transmits the visual detection range map to the user's electronic device for display. The coordinates of the estimated positions can be input by the user into the radar detection range visualization device 1 or obtained by the device's positioning module, such as a GPS module or indoor positioning module.

The visualization module 13 connects the estimated positions to form a closed curve so as to create the visual detection range map. Additionally, the visualization module 13 can annotate the visual detection range map with the signal strength of the microwave signals, the distances between each estimated position and the target radar, and other necessary information. This ensures that the visual detection range map provides various necessary data.

As set forth above, the visualization module 13 can execute the visualization process to generate the visual detection range map according to the coordinates, signal strengths, and distances of the estimated positions relative to the target radar. This enables the radar detection range visualization device 1 to implement a specialized visualization mechanism that automatically generates the visual detection range map. Consequently, the radar detection range visualization device 1 can significantly reduce radar testing time, lowering both time and labor costs, thus meeting actual requirements. Moreover, the visualization module 13 of the radar detection range visualization device 1 can connect the estimated positions to form the closed curve and annotate the visual detection range map with one or more of the signal strength of the microwave signal at each estimated position and the distance between each estimated position and the target radar. This enhances the practical value of the visual detection range map.

The embodiment just exemplifies the present invention and is not intended to limit the scope of the present invention; any equivalent modification and variation according to the spirit of the present invention is to be also included within the scope of the following claims and their equivalents.

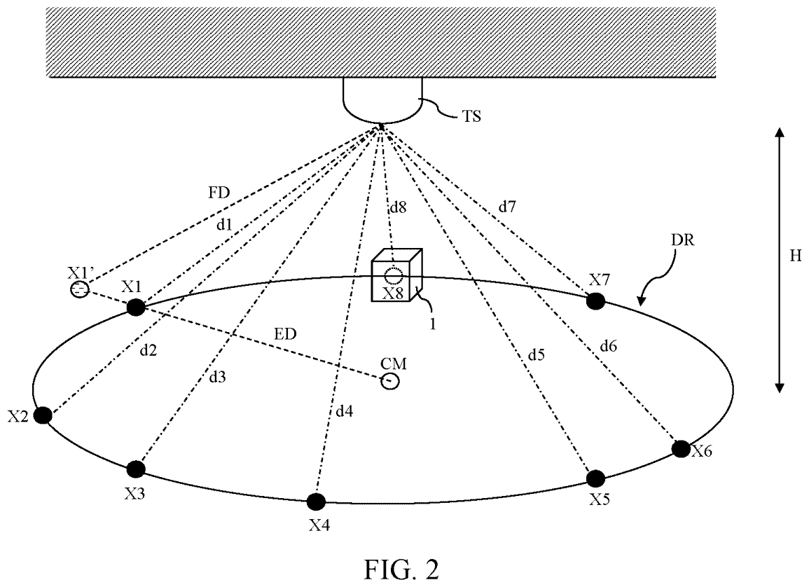

Please refer to FIG. 2, which illustrates a schematic view of the radar detection range visualization device in accordance with one embodiment of the present invention. As shown in FIG. 2, the radar detection range visualization device 1 may be disposed below the target radar TS. The user can select a plurality of estimated positions X1 to X8 based on the possible detection range of the target radar. The number of estimated positions X1 to X8 can vary depending on practical needs. The ranging module 12 calculates the distance between the target radar TS and each of the estimated positions according to the signal strength detected by the signal detection module 11.

When the radar detection range visualization device 1 is disposed at the estimated position X1, the ranging module 12 calculates the distance d1 between the estimated position X1 and the target radar TS according to the signal strength. When the radar detection range visualization device 1 is disposed at the estimated position X2, the ranging module 12 calculates the distance d2 between the estimated position X2 and the target radar TS according to the signal strength. When the radar detection range visualization device 1 is disposed at the estimated position X3, the ranging module 12 calculates the distance d3 between the estimated position X3 and the target radar TS according to the signal strength. When the radar detection range visualization device 1 is disposed at the estimated position X4, the ranging module 12 calculates the distance d4 between the estimated position X4 and the target radar TS according to the signal strength. When the radar detection range visualization device 1 is disposed at the estimated position X5, the ranging module 12 calculates the distance d5 between the estimated position X5 and the target radar TS according to the signal strength. When the radar detection range visualization device 1 is disposed at the estimated position X6, the ranging module 12 calculates the distance d6 between the estimated position X6 and the target radar TS according to the signal strength. When the radar detection range visualization device 1 is disposed at the estimated position X7, the ranging module 12 calculates the distance d7 between the estimated position X7 and the target radar TS according to the signal strength. When the radar detection range visualization device 1 is disposed at the estimated position X8, the ranging module 12 calculates the distance d8 between the estimated position X8 and the target radar TS according to the signal strength. Finally, the visualization module 13 connects the estimated positions X1 to X8 to form a closed curve in order to generate the visual detection range map DR. The visualization module 13 also annotates the visual detection range map DR with the signal strengths of the microwave signals corresponding to the estimated positions X1 to X8, the distances d1 to d8 between the estimated positions X1 to X8 and the target radar TS, and other relevant data.

In another embodiment, the visualization module 13 calculates a corrected position corresponding to any one of the estimated positions when the signal strength of the microwave signal at the estimated position exceeds a preset signal strength. This calculation is based on the signal attenuation rate of the target radar TS, and the corrected position replaces the estimated position to execute the visualization process. The signal strength at the corrected position equals the preset signal strength, which represents the detection capability of the target radar TS. In other words, if the signal strength transmitted by the target radar TS to a location is greater than or equal to the preset signal strength, the target radar TS can detect objects at that location.

For example, if the visualization module 13 determines that the signal strength of the microwave signal at the estimated position X1 exceeds the preset signal strength, the visualization module 13 calculates the maximal detection range FD based on the signal attenuation rate of the target radar TS and the signal strength at the estimated position X1. The visualization module 13 calculates the distance over which the microwave signal attenuates from its current strength to the preset signal strength, adds this distance to the distance d1, and obtains the maximal detection range FD. Subsequently, the visualization module 13 computes the estimated distance ED using the maximal detection range FD and the height H of the target radar TS based on the Pythagorean theorem. Using the center CM of the visual detection range map DR, the coordinates of the estimated position X1, and the estimated distance ED, the visualization module 13 calculates the updated estimated position X1′. Specifically, the visualization module 13 calculates a line segment originating from the center CM of the visual detection range map DR, extending the estimated distance ED, and passing through the estimated position X1. The visualization module 13 then calculates the endpoint of this line segment using the coordinates of the estimated position X1 to obtain the updated estimated position X1′. The visualization module 13 updates the estimated positions X2 to X8 in the same manner to generate an optimized visual detection range map DR.

As described above, the visualization module 13 of the radar detection range visualization device 1 calculates the corrected position corresponding to any one of the estimated positions when the signal strength of the microwave signal of the estimated positions exceeds the preset signal strength. The corrected position replaces the estimated position to execute the visualization process. As a result, the radar detection range visualization device 1 can perform a visual detection range map optimization process to ensure that the visual detection range map DR accurately reflects the actual detection range of the target radar TS, thereby improving the precision of the visual detection range map DR.

The embodiment just exemplifies the present invention and is not intended to limit the scope of the present invention; any equivalent modification and variation according to the spirit of the present invention is to be also included within the scope of the following claims and their equivalents.

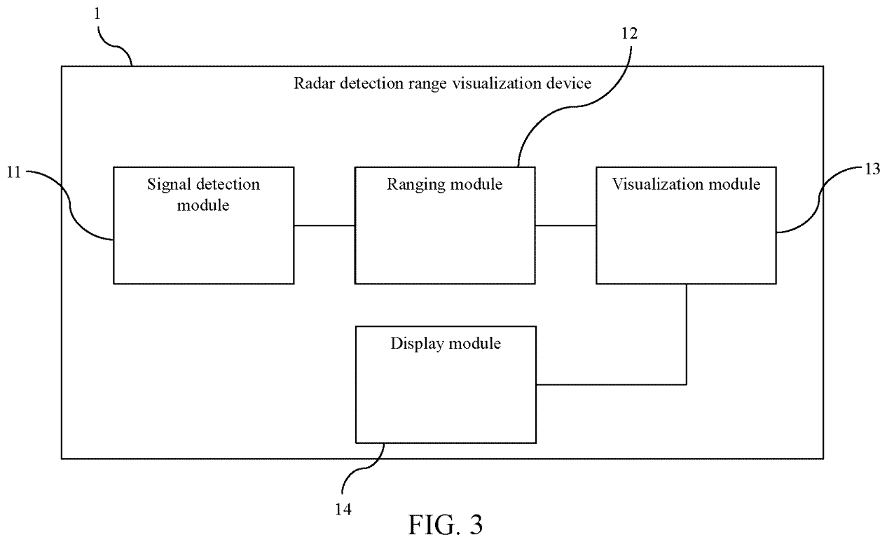

Please refer to FIG. 3, which illustrates a block diagram of a radar detection range visualization device in accordance with another embodiment of the present invention. As shown in FIG. 3, the radar detection range visualization device 1 includes a signal detection module 11, a ranging module 12, and a visualization module 13. The radar detection range visualization device 1 can be positioned below the target radar to execute the visualization process. The ranging module 12 is connected to the signal detection module 11, and the visualization module 13 is connected to the ranging module 12.

Similarly, a user can select a plurality of estimated positions according to the possible detection range of the target radar and place the signal detection module 11 at each estimated position to receive the microwave signal from the target radar. The ranging module 12 calculates the distance between each estimated position and the target radar according to the signal strength of the microwave signal detected by the signal detection module 11 at each estimated position. The visualization module 13 executes a visualization process to generate a visual detection range map according to the coordinates of the estimated positions, the signal strengths of the microwave signals at the estimated positions, and the distances between the estimated positions and the target radar.

The above elements are similar to those in the previous embodiments and will not be redundantly explained here. The difference between this embodiment and the previous embodiment is that the radar detection range visualization device 1 of this embodiment further includes a display module 14. The display module 14 can display the visual detection range map. In one embodiment, the display module 14 may be an LCD, an OLED display, an AMOLED display, or other similar components. Consequently, the radar detection range visualization device 1 becomes more convenient in use and more comprehensive in application, thus meeting diverse application requirements.

Similarly, in this embodiment, the visualization module 13 executes the visualization process to generate the visual detection range map according to the coordinates of the estimated positions, the signal strengths of the microwave signals at the estimated positions, and the distances between the estimated positions and the target radar. This enables the radar detection range visualization device 1 to implement a specialized visualization mechanism, which automatically generates the visual detection range map. Therefore, the radar detection range visualization device 1 can significantly reduce radar testing time, thereby greatly lowering time and labor costs and meeting actual requirements. Furthermore, the visualization module 13 of the radar detection range visualization device 1 can connect the estimated positions to form a closed curve and annotate the visual detection range map with one or more of the following: the signal strength of the microwave signals, the distances to the target radar, or both, to generate the visual detection range map. As a result, the visual detection range map generated by the radar detection range visualization device 1 contains a lot of useful information, so the radar detection range visualization device 1 can conform to actual requirements.

The embodiment just exemplifies the present invention and is not intended to limit the scope of the present invention; any equivalent modification and variation according to the spirit of the present invention is to be also included within the scope of the following claims and their equivalents.

It is worthy to point out that users must conduct extensive testing and subsequently create a detection range diagram based on the test results in order to determine the detection range of a microwave detector. This testing process is highly complex, requiring significant time and manpower. As a result, the currently available testing methods are no longer sufficient to meet actual requirements. By contrast, according to one embodiment of the present invention, the radar detection range visualization device includes a signal detection module, a ranging module and a visualization module. The signal detection module receives a microwave signal from a target radar at each of a plurality of estimated positions. The ranging module calculates the distance between each of the estimated positions and the target radar according to the signal strength of the microwave signal detected by the signal detection module at each of the estimated positions. The visualization module executes a visualization process to generate a visual detection range map according to the coordinate of each of the estimated positions, the signal strength of the microwave signal at each of the estimated positions, and the distance between each of the estimated positions and the target radar. As such, the radar detection range visualization device can implement a specialized visualization mechanism to automatically generate the visual detection range map, which significantly reduces radar testing time, thereby lowering time and labor costs. Accordingly, the radar detection range visualization device can meet actual requirements.

Also, according to one embodiment of the present invention, the visualization module of the radar detection range visualization device can connect the estimated positions to form a closed curve and indicate one or more of the signal strength of the microwave signal at each of the estimated positions and the distance between each of the estimated positions and the target radar, in order to generate the visual detection range map. Consequently, the visual detection range map produced by the radar detection range visualization device can include a lot of useful information, such that the radar detection range visualization device can conform to actual requirements.

Further, according to one embodiment of the present invention, the visualization module of the radar detection range visualization device can calculate a corrected position corresponding to any one of the estimated positions according to a signal attenuation rate of the target radar when the signal strength of the microwave signal corresponding to the estimated position exceeds a preset signal strength, and replace the estimated position with the corrected position to execute the visualization program. In this way, the radar detection range visualization device can execute a visual detection range map optimization process in order to enable the visual detection range map to accurately display the actual detection range of the target radar, which can improve the precision of the visual detection range map.

Moreover, according to one embodiment of the present invention, the radar detection range visualization device further includes a display module capable of directly displaying the visual detection range map. The display module makes the radar detection range visualization device be more convenient in use and more comprehensive in application. Thus, the radar detection range visualization device can meet the requirements of different applications.

Furthermore, according to one embodiment of the present invention, the radar detection range visualization device features a simple design and offers a variety of functions. As such, the radar detection range visualization device achieves higher practicality and can be applied to various intelligent applications. Consequently, the radar detection range visualization device aligns with future development trends. As previously stated, the radar detection range visualization device according to the embodiments of the present invention can achieve great technical effects.

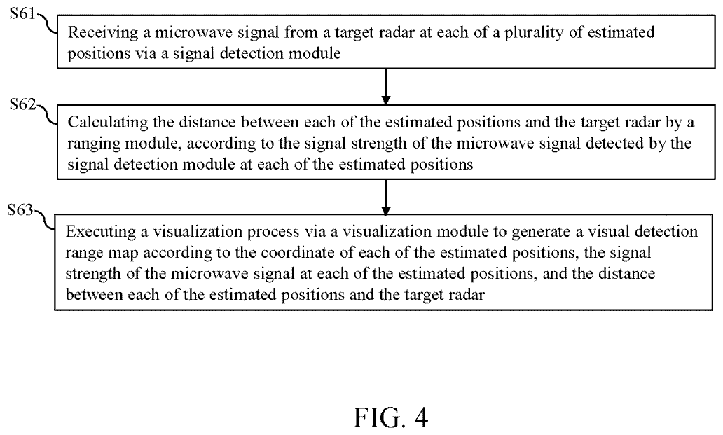

Please refer to FIG. 4, which illustrates a flow chart of a radar detection range visualization method in accordance with still another embodiment of the present invention. As shown in FIG. 4, the radar detection range visualization method according to the embodiment of the present invention includes the following steps:

Step S41: receiving a microwave signal from a target radar at each of a plurality of estimated positions via a signal detection module.

Step S42: calculating the distance between each of the estimated positions and the target radar by a ranging module, according to the signal strength of the microwave signal detected by the signal detection module at each of the estimated positions.

Step S43: executing a visualization process via a visualization module to generate a visual detection range map according to the coordinate of each of the estimated positions, the signal strength of the microwave signal at each of the estimated positions, and the distance between each of the estimated positions and the target radar. In this step, the visualization module connects the estimated positions to form a closed curve and indicates one or more of the signal strength of the microwave signal at each of the estimated positions and the distance between each of the estimated positions and the target radar, in order to generate the visual detection range map. In addition, the visualization module calculates a corrected position corresponding to any one of the estimated positions according to the signal attenuation rate of the target radar when the signal strength of the microwave signal corresponding to the estimated position exceeds a preset signal strength, and replaces the estimated position with the corrected position to execute the visualization process.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the present invention, the radar detection range visualization device includes a signal detection module, a ranging module and a visualization module. The signal detection module receives a microwave signal from a target radar at each of a plurality of estimated positions. The ranging module calculates the distance between each of the estimated positions and the target radar according to the signal strength of the microwave signal detected by the signal detection module at each of the estimated positions. The visualization module executes a visualization process to generate a visual detection range map according to the coordinate of each of the estimated positions, the signal strength of the microwave signal at each of the estimated positions, and the distance between each of the estimated positions and the target radar. As such, the radar detection range visualization device can implement a specialized visualization mechanism to automatically generate the visual detection range map, which significantly reduces radar testing time, thereby lowering time and labor costs. Accordingly, the radar detection range visualization device can meet actual requirements.

Also, according to one embodiment of the present invention, the visualization module of the radar detection range visualization device can connect the estimated positions to form a closed curve and indicate one or more of the signal strength of the microwave signal at each of the estimated positions and the distance between each of the estimated positions and the target radar, in order to generate the visual detection range map. Consequently, the visual detection range map produced by the radar detection range visualization device can include a lot of useful information, such that the radar detection range visualization device can conform to actual requirements.

Further, according to one embodiment of the present invention, the visualization module of the radar detection range visualization device can calculate a corrected position corresponding to any one of the estimated positions according to a signal attenuation rate of the target radar when the signal strength of the microwave signal corresponding to the estimated position exceeds a preset signal strength, and replace the estimated position with the corrected position to execute the visualization program. In this way, the radar detection range visualization device can execute a visual detection range map optimization process in order to enable the visual detection range map to accurately display the actual detection range of the target radar, which can improve the precision of the visual detection range map.

Moreover, according to one embodiment of the present invention, the radar detection range visualization device further includes a display module capable of directly displaying the visual detection range map. The display module makes the radar detection range visualization device be more convenient in use and more comprehensive in application. Thus, the radar detection range visualization device can meet the requirements of different applications.

Furthermore, according to one embodiment of the present invention, the radar detection range visualization device features a simple design and offers a variety of functions. As such, the radar detection range visualization device achieves higher practicality and can be applied to various intelligent applications. Consequently, the radar detection range visualization device aligns with future development trends.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A radar detection range visualization device, comprising:
a signal detection module configured to receive a microwave signal from a target radar at each of a plurality of estimated positions;
a ranging module configured to calculate a distance between each of the estimated positions and the target radar according to a signal strength of the microwave signal detected by the signal detection module at each of the estimated positions; and
a visualization module configured to execute a visualization process to generate a visual detection range map according to a coordinate of each of the estimated positions, the signal strength of the microwave signal at each of the estimated positions, and the distance between each of the estimated positions and the target radar.

2. The radar detection range visualization device as claimed in claim 1, wherein the visualization module is configured to connect the estimated positions to form a closed curve and indicate one or more of the signal strength of the microwave signal at each of the estimated positions and the distance between each of the estimated positions and the target radar, in order to generate the visual detection range map.

3. The radar detection range visualization device as claimed in claim 1, wherein the visualization module is configured to calculate a corrected position corresponding to any one of the estimated positions according to a signal attenuation rate of the target radar when the signal strength of the microwave signal corresponding to the estimated position exceeds a preset signal strength, and replace the estimated position with the corrected position to execute the visualization process.

4. The radar detection range visualization device as claimed in claim 3, wherein a signal strength of the microwave signal corresponding to the corrected position is equal to the preset signal strength.

5. The radar detection range visualization device as claimed in claim 1, further comprising a display module configured to display the visual detection range map.

6. A radar detection range visualization method, comprising:
receiving a microwave signal from a target radar at each of a plurality of estimated positions via a signal detection module;
calculating a distance between each of the estimated positions and the target radar by a ranging module, according to a signal strength of the microwave signal detected by the signal detection module at each of the estimated positions; and
executing a visualization process via a visualization module to generate a visual detection range map according to a coordinate of each of the estimated positions, the signal strength of the microwave signal at each of the estimated positions, and the distance between each of the estimated positions and the target radar.

7. The radar detection range visualization method as claimed in claim 6, wherein a step of executing the visualization process via the visualization module to generate the visual detection range map according to the coordinate of each of the estimated positions, the signal strength of the microwave signal at each of the estimated positions, and the distance between each of the estimated positions and the target radar further comprising: connecting the estimated positions to form a closed curve and indicate one or more of the signal strength of the microwave signal at each of the estimated positions and the distance between each of the estimated positions and the target radar by the visualization module in order to generate the visual detection range map.

8. The radar detection range visualization method as claimed in claim 6, wherein a step of executing the visualization process via the visualization module to generate the visual detection range map according to the coordinate of each of the estimated positions, the signal strength of the microwave signal at each of the estimated positions, and the distance between each of the estimated positions and the target radar further comprising: calculating a corrected position corresponding to any one of the estimated positions according to a signal attenuation rate of the target radar when the signal strength of the microwave signal corresponding to the estimated position exceeds a preset signal strength, and replacing the estimated position with the corrected position to execute the visualization process by the visualization module.

9. The radar detection range visualization method as claimed in claim 6, wherein a signal strength of the microwave signal at the corrected position is equal to the preset signal strength.

10. The radar detection range visualization method as claimed in claim 6, further comprising:
displaying the visual detection range map by a display module.
